(19) United States
(12) Patent Application Publication
(10) Pub. No.: US 2017/0315943 A1
(43) Pub. Date: Nov. 2, 2017

(54) SYSTEMS AND METHODS FOR PERFORMING DIRECT MEMORY ACCESS (DMA) OPERATIONS

(71) Applicant: SANDISK TECHNOLOGIES INC., PLANO, TX (US)

(72) Inventors: SHAY BENISTY, BEER SHEVA (IL); TAL SHARIFIE, LEHAVIM (IL)

(21) Appl. No.: 15/142,342

(22) Filed: Apr. 29, 2016

(51) Int. Cl. G06F 13/28; G06F 12/1081; G06F 13/16; G06F 13/42

(52) U.S. Cl. CPC G06F 13/28; G06F 13/4282; G06F 12/1081; G06F 13/1673; G06F 2212/656

(57) ABSTRACT

A data storage device includes a memory and a controller coupled to the memory. The controller includes an interface to enable the controller to be coupled to an access device that includes a direct memory access (DMA) engine. The controller is configured to instruct the access device to perform an access device DMA operation to transfer data from a first location of a memory of the access device to a second location of the memory of the access device.

### FIELD OF THE DISCLOSURE

The present disclosure is generally related to direct memory access (DMA) operations.

### BACKGROUND

Non-volatile data storage devices, such as universal serial bus (USB) flash memory devices or removable storage cards, have allowed for increased portability of data and software applications. Flash memory devices can enhance data storage density by storing multiple bits in each flash memory cell.

A data storage device may receive a write instruction from an access device (e.g., a host device) to write data stored a first location of access device memory to a memory of the data storage device. The data storage device may partially execute the write instruction by transferring the data from the first location to a second location of access device memory that is allocated for exclusive use by the data storage device (e.g., to a host memory buffer (HMB)). The data storage device may execute the transfer using a direct memory access (DMA) engine (e.g., a DMA controller) on the data storage device. To execute the transfer, the DMA engine on the data storage device may read the data from the first location of the access device memory (using a first data transfer operation across an interface between the data storage device and the access device). The DMA engine on the data storage device may subsequently write the data to the second location of the access device memory (using a second data transfer operation across the interface). Thus, the data may be transferred across the interface twice during execution of the write instruction by the DMA engine. Transferring the data across the interface twice during execution of the write instruction may unnecessarily add traffic across the interface.

### BRIEF DESCRIPTION OF THE DRAWINGS

FIG. 1 is a diagram of a particular illustrative example of a system that includes a data storage device coupled to an access device coupled to or including an access device memory;

FIG. 2 is a diagram of a particular illustrative example of a completion queue entry;

FIG. 3 is a flow chart of a particular illustrative embodiment of a method of initiating, by a data storage device, an access device DMA operation to transfer data from a first portion of access device memory to a second portion of the access device memory by sending access device DMA parameters to an address of an access device DMA engine;

FIG. 4 is a flow chart of a particular illustrative embodiment of a method of initiating, by a data storage device, an access device DMA operation to transfer data from a first portion of access device memory to a second portion of the access device memory by posting a completion queue entry that includes access device DMA parameters to a completion queue of the access device memory;

FIG. 5 is a flow chart of a particular illustrative embodiment of a method of initiating, by an access device, an access device DMA operation to transfer data from a first portion of access device memory to a second portion of the access device memory responsive to a data storage device writing access device DMA parameters to an address of an access device DMA engine;

FIG. 6 is a flow chart of a particular illustrative embodiment of a method of initiating, by an access device, an access device DMA operation to transfer data from a first portion of access device memory to a second portion of the access device memory responsive to a data storage device posting a completion queue entry that includes access device DMA parameters to a completion queue of the access device memory;

FIG. 7A is a block diagram of a particular illustrative embodiment of a non-volatile memory system;

FIG. 7B is a block diagram of a particular illustrative embodiment of a storage module including a plurality of the non-volatile memory systems of FIG. 7A;

FIG. 7C is a block diagram of a particular illustrative embodiment of a hierarchical storage system;

FIG. 8A is a block diagram of components of a particular illustrative embodiment of a controller; and

FIG. 8B is a block diagram of components of a particular illustrative embodiment of a non-volatile memory die.

### DETAILED DESCRIPTION

Particular aspects of the disclosure are described below with reference to the drawings. In the description, common features are designated by common reference numbers. As used herein, “exemplary” may indicate an example, an implementation, and/or an aspect, and should not be construed as limiting or as indicating a preference or a preferred implementation.

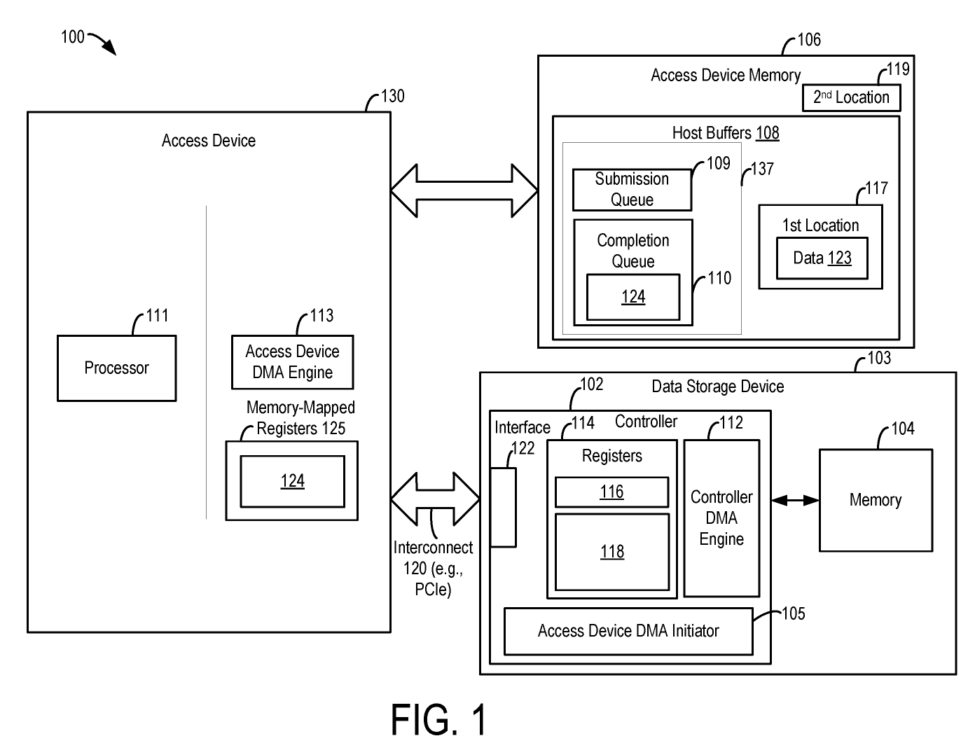

Referring to FIG. 1, a particular embodiment of a system 100 includes a data storage device 103 coupled to an access device 130. The data storage device 103 includes a memory 104 and a controller 102 coupled to the memory 104. The access device 130 may be configured to provide data to be stored at the memory 104 of the data storage device 103 or to request data to be read from the memory 104.

The access device 130 may include or may be coupled to an access device memory (e.g., a “memory of the access device”) 106. The access device memory 106 may store one or more host buffers 108. The one or more host buffers 108 may store one or more queues, such as an administrative queue 137. The administrative queue 137 may include a submission queue 109 and a completion queue 110. The submission queue 109 may be a circular buffer with a fixed slot size that the access device 130 uses to submit commands for execution by the controller 102. The completion queue 110 may be a circular buffer with a fixed slot size used by the controller 102 to post status for completed commands. The access device 130 may be configured to post asynchronous event requests (“AERs”) in the submission queue 109, and the data storage device 103 may be configured to post responses to AERs in the completion queue 110. The access device 130 may be configured to post an AER (to the submission queue 109) that is dedicated to a data processing instruction such that a response (by the data storage device 103) to the dedicated AER (e.g., a submission queue entry) will be interpreted by the access device 130 as parameters (e.g., access device DMA parameters 124) that initiate or enable the access device DMA engine 113 to perform an access device DMA operation. The access device DMA parameters that may be included in the completion queue entry are described in more detail below.

The access device memory 106 may include a host memory buffer (HMB), e.g., at a second location 119. The HMB may be allocated for use by the controller 102 at the access device memory 106.

The access device 130 may include a processor 111 (e.g., a central processing unit (CPU)). The access device 130 may include an access device direct memory access (DMA) engine 113 (e.g., a DMA controller) configured to enable the access device 130 to access main system memory (e.g., the access device memory 106) independently of the processor 111. The access device DMA engine 113 may be associated with one or more memory-mapped registers 125. The one or more memory-mapped registers 125 may be control registers that are configured to store information to execute DMA operations of the access device DMA engine 113. For example, the access device DMA engine 113 may be configured to interpret information sent to or written in the one or more memory-mapped registers 113 as parameters (e.g., “access device parameters” 124) that initiate or enable a DMA operation.

The access device 130 may include a mobile telephone, a music player, a video player, a gaming console, an electronic book reader, a personal digital assistant (PDA), a computer, such as a laptop computer or notebook computer, any other electronic device, or any combination thereof. The controller 102 may include an interface 122 that enables the access device 130 to communicate with the data storage device 103 (e.g., including the memory 104) across an interconnect 120 (e.g., a peripheral component interconnect (PCIe) bus). Among other things, the interface 122 and the interconnect 120 enables the access device 130 to read from the memory 104 and to write to the memory 104. For example, the access device 130 may operate in compliance with a Joint Electron Devices Engineering Council (JEDEC) industry specification, such as a Universal Flash Storage (UFS) Host Controller Interface specification. As other examples, the access device 130 may operate in compliance with one or more other specifications, such as a Secure Digital (SD) Host Controller specification as an illustrative example. The access device 130 may communicate with the memory 104 in accordance with any other suitable communication protocol.

The memory 104 may be a non-volatile memory, such as a NAND flash memory. For example, the data storage device 103 may be a memory card, such as a Secure Digital SD® card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). As another example, the data storage device 103 may be configured to be coupled to the access device 130 as embedded memory, such as eMMC® (trademark of JEDEC Solid State Technology Association, Arlington, Va.) and eSD, as illustrative examples. To illustrate, the data storage device 103 may correspond to an eMMC (embedded MultiMedia Card) device. The data storage device 103 may operate in compliance with a JEDEC industry specification. For example, the data storage device 103 may operate in compliance with a JEDEC eMMC specification, a JEDEC Universal Flash Storage (UFS) specification, one or more other specifications, or a combination thereof.

The controller 102 is configured to receive data and instructions from and to send data to the access device 130 while the data storage device 103 is operatively coupled to the access device 130. The controller 102 is further configured to send data and commands to the memory 104 and to receive data from the memory 104. For example, the controller 102 is configured to send data and a write command to instruct the memory 104 to store the data to a specified address. As another example, the controller 102 is configured to send a read command to read data from a specified address of the memory 104.

The controller 102 includes a controller direct memory access (DMA) engine 112. The controller DMA engine 112 may be configured to enable the data storage device 103 to access main system memory (e.g., the access device memory 106) independently of a CPU. The controller 102 may include registers 114. The registers 114 may include registers 116 (e.g., doorbell registers) and one or more registers 118. The one or more registers 118 may be vendor specific registers.

The controller 102 may include an access device DMA initiator 105. The controller 102 (e.g., the access device DMA initiator 105) may be configured to instruct the access device 130 to perform an access device DMA operation to transfer data 123 from a first location 117 of the access device memory 106 to a second location 119 of the access device memory 106 as described in more detail below (e.g., by sending a translation layer packet or posting a completion queue entry to the completion queue 110). In some examples, the first location 117 of the access device memory 106 may correspond to a location of a buffer of the one or more host buffers 108. Alternatively or additionally, the second location 119 of the access device memory 106 may correspond to a location of a HMB.

In some examples, the controller 102 is configured to instruct the access device 130 to transfer the data 123 by writing information (e.g., access device DMA parameters 124) to the access device 130 at an address (of a memory or storage element) that is associated with the access device DMA engine 113. For example, the address associated with the access device DMA engine 113 may correspond to an address of at least one of the one or more memory-mapped registers 125. As described above, the one or more memory-mapped registers 125 may be configured to be written with the access device DMA parameters 124, which may initiate or enable the access device DMA engine 113 to perform a DMA operation. The controller 102 may determine the address of the memory element that is associated with the access device DMA engine 113 based on information stored in the one or more registers 118. For example, the access device 130 may be configured to send the address associated with the memory element of the access device DMA engine 113 to the controller 102 to be stored at the one or more registers 118, and the controller 102 may be configured to read the one or more registers 118 to determine the address. Thus, the controller 102 may determine the address associated with the memory element of the access device DMA engine 113 (and therefore the address at which to write the access device DMA parameters 124) based on information sent or written to the one or more registers 118 from or by the access device 130.

The information may enable the access device 130 (e.g., the processor 111) to determine the first location 117 (e.g., an address of a source location of the data 123) and the second location 119 (e.g., an address of a destination location for the data 123). In some examples, the access device DMA parameters 124 may be included in a translation layer packet (e.g., a single translation layer packet). Writing the access device DMA parameters 124 to the access device 130 using a single translation layer packet may increase performance of the interconnect 120 (e.g., the PCIe bus). In some examples, the translation layer packet may include a source address field that describes the source address of the data 123 (e.g., the address of the first location 117), a destination address field that describes the destination address for the data 123 (e.g., the address of the second location 119), and a transfer size field that describes a size of the data 123.

The access device 130 may be configured to perform the access device DMA operation responsive to the access device DMA parameters 124 being sent or written to the address of the access device DMA engine 113 (e.g., the address sent to the data storage device 103 by the access device 130 and stored in the one or more registers 118). For example, sending or writing the access device DMA parameters 124 to the address of the access device DMA engine 113 may trigger the processor 111 or the access device DMA engine 113 to copy the data 123 from the first location 117 to the second location 119 based on the transfer size or may trigger the processor 111 to cause the access device DMA engine 113 to copy the data 123 from the first location to the second location 119 based on the transfer size.

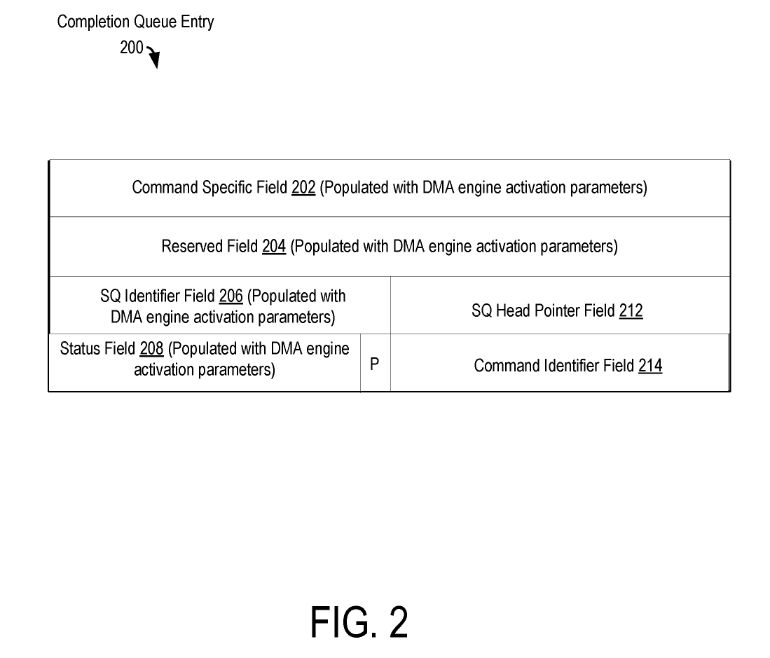

In other examples, the controller 102 is configured to instruct the access device 130 to transfer the data 123 by posting a completion queue entry to the completion queue 110. The completion queue entry includes parameters (e.g., the access device DMA parameters 124) to activate the DMA engine 113 (or to cause the processor 111 to instruct the DMA engine 113) to perform the access device DMA operation. An example of a completion queue entry that includes access device DMA parameters 124 is described in more detail with reference to FIG. 2.

In some examples, the controller 102 may post the completion queue entry after receiving a data processing instruction from the access device 130. The controller 102 may post the completion queue entry after the controller 102 receives an asynchronous event request (AER) command.

For example, the access device 130 may send the controller a write instruction to write the data 123 to the memory 104. In this example, there may not be a pending AER command in the submission queue 109 when the controller 102 receives the write instruction. In this case, after receiving the write instruction, the controller 102 may be configured to wait for the AER command to be posted to the submission queue 109. In this example, once the AER command is posted to the submission queue 109, the controller 102 may post the completion queue entry to the completion queue 110.

Alternatively, there may be a pending AER command when the controller 102 receives the write instruction (e.g., the access device 130 may have posted a pending AER command to the submission queue 109 prior to sending the controller 102 the write instruction). In this case, the controller 102 may use the pending AER command to effect the access device DMA operation without waiting for another AER to be posted to the submission queue 109. In this example, once the controller 102 receives the write instruction, the controller 102 may post a completion queue entry associated with the pending AER command to the completion queue 110.

In response to the completion queue entry being posted to the completion queue 110, the access device 130 may perform the access device DMA operation to transfer the data 123 from the first location 117 to the second location 119 based on the access device DMA parameters 124 included in the completion queue entry. For example, in response to the completion queue entry being posted to the completion queue 110, the access device 130 (e.g., the processor 111) may cause the access device DMA engine 113 to fetch the data 123 at the first location 117 based on the access device DMA parameters 124 in the completion queue entry that identifies an address (e.g., a source address) of the data 123 and a size of the data 123. The access device 130 (e.g., the processor 111) may subsequently cause the access device DMA engine 113 to write the data 123 to the second location 119 based on the access device DMA parameters 124 in the completion queue entry that identifies a destination address (e.g., an address of the second location 119).

Thus, the controller 102 may be configured to effect transfer of the data 123 from the first location 117 to the second location 119 without the data 123 being transferred over the interconnect 120 by initiating (e.g., using the translation layer packet or the completion queue entry) the access device 130 (e.g., the processor 111 and the access device DMA engine 113) to perform the transfer of the data 123. Performing the data transfer process without transferring the data 123 over the interconnect 120 may improve performance of the interconnect 120 compared to systems in which the data transfer operation includes the controller 102 reading the data from the first location 117 (e.g., using a first data transfer across the interconnect 120) and writing the data to the second location 119 (e.g., using a second data transfer across the interconnect 120).

Referring to FIG. 2, a particular embodiment of a completion queue entry 200 that includes the access device DMA parameters 124 is illustrated. The completion queue entry 200 includes a command specific field 202, a reserved field 204, a submission queue (SQ) identifier field 206, a status field 208, a SQ head pointer field 212, a command identifier field 214, or a combination thereof. The controller 102 may be configured to populate one or more of the fields 202, 204, 206, 208, 212, or 214 with the access device DMA parameters 124. For example, the controller 102 may populate the command specific field 202 with information that enables the access device 130 to identify the first location 117 (e.g., a source address of the data 123), the second location 119 (e.g., a destination address of the data 123), or a size of the data 123 that is the subject of the data processing instruction. Additionally or alternatively, the controller 102 may populate the reserved field 204 with information that enables the access device 130 to identify the first location 117 (e.g., a source address of the data 123), the second location 119 (e.g., a destination address of the data 123), or a size of the data 123 that is the subject of the data processing instruction. Additionally or alternatively, the controller 102 may populate the SQ identifier field 206 with information that enables the access device 130 to identify the first location 117 (e.g., a source address of the data 123), the second location 119 (e.g., a destination address of the data 123), or a size of the data 123 that is the subject of the data processing instruction. Additionally or alternatively, the controller 102 may populate the status field 208 with information that enables the access device 130 to identify the first location 117 (e.g., a source address of the data 123), the second location 119 (e.g., a destination address of the data 123), or a size of the data 123 that is the subject of the data processing instruction. Thus, the completion queue entry posted by the controller 102 to the completion queue 110 may include the access device DMA parameters 124 in completion queue fields that enable the access device 130 to access the data 123 at the first location 117 and to transfer the data 123 to the second location 119.

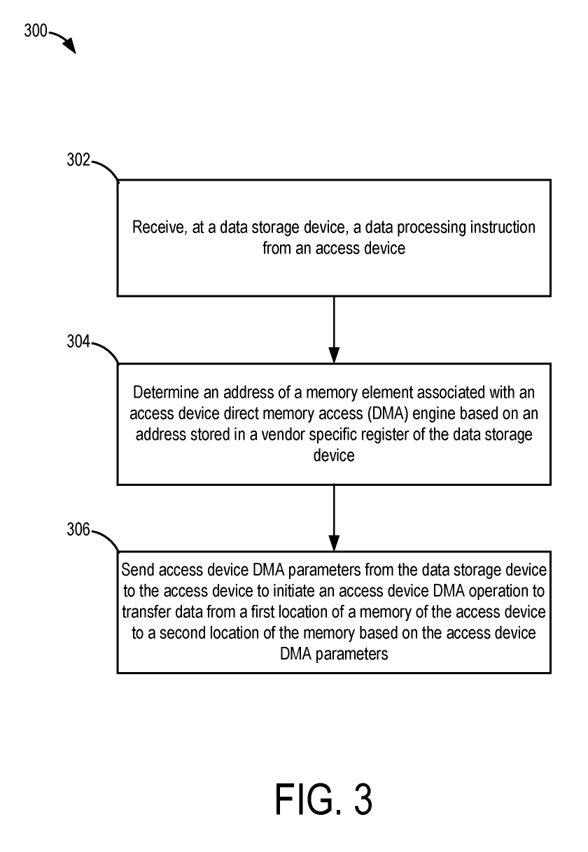

Referring to FIG. 3, a particular illustrative example of a method is depicted and generally designated 300. The method 300 may be performed at a data storage device, such as at the data storage device 103 of FIG. 1.

The method 300 includes receiving, at 302, at a data storage device 103, a data processing instruction from an access device, such as the access device 130 of FIG. 1. For example, the data processing instruction may correspond to a read instruction to read data from the memory 104 or a write instruction to write data (e.g., the data 123) to the memory 104. In some examples, the data indicated as the subject of the write instruction by the access device 130 may be stored by the access device at the first location 117 (e.g., at a host buffer of one or more host buffers) of the access device memory 106.

The method 300 may include, at 304, determining an address (of a memory or storage element) that is associated with an access device DMA engine (e.g., the access device DMA engine 113 of FIG. 1) based on an address stored in the one or more registers 118 of the data storage device 103 (e.g., of the controller 102). For example, the address associated with the access device DMA engine 113 may be an address of the one or more registers 125 described above with reference to FIG. 1. As described above, the access device 130 may send the address associated with the access device DMA engine 113 to the controller 102 to be stored at the one or more registers 118. In some examples, the one or more registers 118 may be vendor specific registers.

The method 300 may include, at 306, sending access device DMA parameters (such as the access device DMA parameters 124 of FIG. 1) from the data storage device 103 to the access device 130 to initiate an access device DMA operation to transfer data from a first location of a memory of the access device to a second location of the memory of the access device based on the access device DMA parameters 124. In some examples, the memory of the access device may correspond to the access device memory 106, the data may correspond to the data 123, the first location may correspond to the first location 117, and the second location may correspond to the second location 119. In some examples, the controller 102 may send (e.g., write) the access device DMA parameters 124 to the address (of the memory element) associated with the access device DMA engine as determined by reading the one or more registers 118. Sending the access device DMA parameters to the access device 130 may include generating and populating (e.g., by the access device DMA initiator 105 of FIG. 1) the translation layer packet with the access device DMA parameters.

The access device DMA parameters 124 may correspond to the information described above with reference to FIG. 1. The access device DMA parameters 124 may enable the access device 130 (e.g., the processor 111 or the access device DMA engine 113) to determine the first location 117 and the second location 119. In some examples, the access device DMA parameters sent to the access device DMA engine 113 may be included in a translation layer packet (e.g., a single translation layer packet) as described above with reference to FIG. 1. Sending the access device DMA parameters 124 to the access device 130 using a single translation layer packet may increase performance of the interconnect 120 (e.g., the PCIe bus). In some examples, the translation layer packet may include a source address field that describes the source address of the data 123 (e.g., the address of the first location 117), a destination address field that describes the destination address for the data 123 (e.g., the address of the second location 119), and a transfer size field that describes a size of the data 123.

In response to the access device DMA parameters 124 being sent to the access device 130 (e.g., to the address (of the memory element) associated with the access device DMA engine 113), the access device 130 (e.g., the processor 111 or the access device DMA engine 113) may fetch the data 123 from the first location 117 as determined based on the access device DMA parameters 124. In some examples, the processor 111 may cause the access device DMA engine 113 to fetch the data 123 from the first location 117 as determined based on the access device DMA parameters 124. The access device 130 (e.g., the processor 111 or the access device DMA engine 113) may subsequently write the data 123 to the second location 119 as determined based on the access device DMA parameters 124. In some examples, the processor 111 may cause the access device DMA engine 113 to write the data 123 to the second location 119 as determined based on the access device DMA parameters 124. The access device 130 performs the fetch and write operations to fetch and write the data 123 from the first location 117 to the second location 119 using transactions between the access device memory 106 and the access device 130 (e.g., without transferring the data 123 across the interconnect 120).

Thus, the controller 102 may be configured to effect transfer of the data 123 from the first location 117 to the second location 119 without the data 123 being transferred over the interconnect 120. Performing the data transfer process without transferring the data 123 over the interconnect 120 may improve performance of the interconnect 120 compared to systems in which the data transfer operation includes the controller 102 reading the data 123 from the first location 117 (e.g., using a first data transfer operation across the interconnect 120) and writing the data 123 to the second location 119 (e.g., using a second data transfer operation across the interconnect 120).

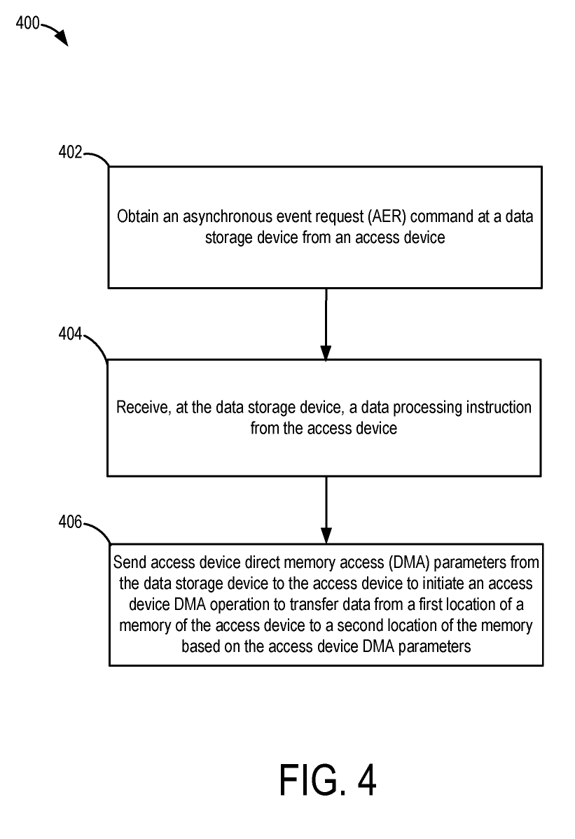

Referring to FIG. 4, a particular illustrative example of a method is depicted and generally designated 400. The method 400 may be performed at a data storage device, such as at the data storage device 103 of FIG. 1.

The method 400 includes obtaining, at 402, an AER command (as described above with reference to FIG. 1) at a data storage device (such as the data storage device 103 of FIG. 1). The AER command may be posted to a submission queue (such as the submission queue 109 of FIG. 1) by an access device (such as the access device 130 of FIG. 1), and the data storage device 103 may obtain the AER command from the submission queue. The method 400 further includes receiving, at 404, at the data storage device, a data processing instruction from the access device. For example, the data processing instruction may correspond to a read instruction to read data from the memory 104 or a write instruction to write data (e.g., the data 123) to the memory 104. In some examples, the data indicated as the subject of the write instruction by the access device 130 may be stored by the access device 130 at the first location 117 (e.g., at a host buffer of one or more host buffers) of the access device memory 106.

Although FIG. 4 illustrates obtaining the AER command before receiving the data processing instruction, in other examples, the AER command may be obtained after the data processing instruction is received as described above with reference to FIG. 1.

The method 400 may include, at 406, sending access device DMA parameters, such as the access device DMA parameters 124 of FIG. 1, from the data storage device 103 to the access device 130 (e.g., to the access device memory 106) to initiate an access device DMA operation to transfer data from the first location 117 of a memory of the access device (e.g., the access device memory 106) to a second location 119 of the memory (e.g., the access device memory 106) based on the access device DMA parameters 124. The access device DMA parameters 124 may enable the access device (e.g., the processor 111 or the access device DMA engine 113) to determine the first location 117 (e.g., an address of the first location 117) and the second location 119 (e.g., an address of the second location 119).

In some examples, the access device DMA parameters 124 may be included in a completion queue entry that is posted (e.g., written) by the data storage device 103 to a completion queue, such as the completion queue 110 of FIG. 1, on the access device memory 106. In some examples, the completion queue entry may correspond to the completion queue entry described above with reference to FIG. 2. To illustrate, sending the access device DMA parameters 124 to the access device 130 may include generating and populating (e.g., by the access device DMA initiator 105 of FIG. 1) the completion queue entry with the access device DMA parameters 124 as described above with reference to FIGS. 1 and 2.

In response to the access device DMA parameters 124 being posted to the completion queue 110, the access device 130 (e.g., the processor 111 or the access device DMA engine 113) may fetch the data 123 from the first location 117 as determined based on the access device DMA parameters 124. In some examples, the processor 111 may cause the access device DMA engine 113 to fetch the data 123 from the first location 117 as determined based on the access device DMA parameters 124. The access device 130 (e.g., the processor 111 or the access device DMA engine 113) may subsequently write the data 123 to the second location 119 as determined based on the access device DMA parameters 124. In some examples, the processor 111 may cause the access device DMA engine 113 to write the data 123 to the second location 119 as determined based on the access device DMA parameters 124. The access device 130 performs the fetch and write operations to fetch and write the data 123 from the first location 117 to the second location 119 using transactions between the access device memory 106 and the access device 130 (e.g., without transferring the data 123 across the interconnect 120).

Thus, the controller 102 may be configured to effect transfer of the data 123 from the first location 117 to the second location 119 without the data being transferred over the interconnect 120. Performing the data transfer process without transferring the data 123 over the interconnect 120 may improve performance of the interconnect 120 compared to systems in which the data transfer operation includes the controller 102 reading the data 123 from the first location 117 (e.g., using a first data transfer across the interconnect 120) and writing the data 123 to the second location 119 (e.g., using a second data transfer across the interconnect 120).

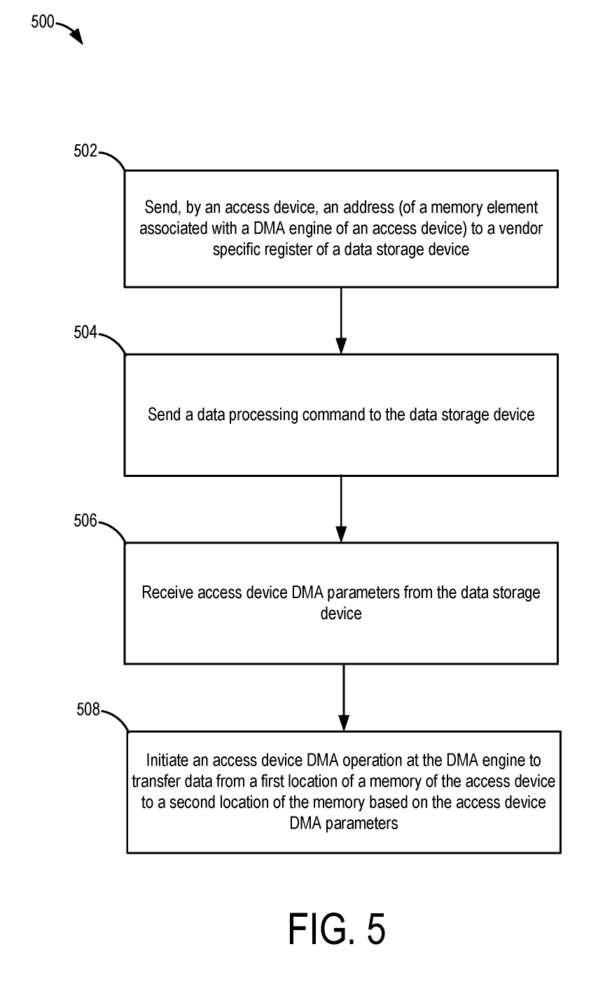

Referring to FIG. 5, a particular illustrative example of a method is depicted and generally designated 500. The method 500 may be performed at an access device, such as at the access device 130 of FIG. 1.

The method 500 includes sending, at 502, an address (of a memory element) associated with a DMA engine of the access device 130 (e.g., the access device DMA engine 113 of FIG. 1) to a register of a data storage device, such as the data storage device 103. The register may correspond to the one or more registers 118, which may be vendor specific registers. The memory element associated with the access device DMA engine 113 may correspond to the one or more memory-mapped registers 125 as described above with reference to FIG. 1.

The method 500 may include sending, at 504, a data processing command or instruction to the data storage device 103 (e.g., to the controller 102). For example, the data processing instruction may correspond to a read instruction to read data from the memory 104 or a write instruction to write data (e.g., the data 123) to the memory 104. In some examples, the data indicated as the subject of the write instruction by the access device 130 may be stored by the access device at the first location 117 (e.g., at a host buffer of one or more host buffers) of the access device memory 106.

The method 500 may include, at 506, receiving access device DMA parameters, such as the access device DMA parameters 124 of FIG. 1, from the data storage device 103. In response to receiving the access device DMA parameters 124, the access device 130 may initiate an access device DMA operation to transfer data from the first location 117 of a memory of the access device (e.g., the access device memory 106) to a second location 119 of the memory (e.g., the access device memory 106) based on the access device DMA parameters 124 as described above with reference to FIG. 1.

The access device DMA parameters 124 may enable the access device 130 (e.g., the processor 111) to determine the first location 117 (e.g., an address of the first location 117) and the second location 119 (e.g., an address of the second location 119) as described above with reference to FIG. 1. In some examples, the access device DMA parameters 124 sent to the access device DMA engine 113 may be included in a translation layer packet (e.g., a single translation layer packet). Sending the access device DMA parameters 124 to the access device 130 using a single translation layer packet may increase performance of the interconnect 120 (e.g., the PCIe bus). In some examples, the translation layer packet may include a source address field that describes the source address of the data 123 (e.g., the address of the first location 117), a destination address field that describes the destination address for the data 123 (e.g., the address of the second location 119), and a transfer size field that describes a size of the data 123.

The method 500 may include, at 508, initiating an access device DMA operation at the DMA engine 113 of the access device 130 to transfer data from a first location of the memory of the access device to a second location of the memory of the access device based on the access device DMA parameters. For example, the access device DMA engine 113 may fetch the data 123 from the first location 117 determined based on the access device DMA parameters and may write the data 123 to the second location 119 determined based on the access device DMA parameters. The access device 130 (e.g., the access device DMA engine 113) performs the fetch and write operations to fetch and write the data 123 from the first location 117 to the second location 119 using transactions between the access device memory 106 and the access device 130 (e.g., without transferring the data 123 across the interconnect 120).

Thus, the access device 130 may be configured to transfer the data 123 from the first location 117 to the second location 119 based on the access device DMA parameters being sent to the access device DMA engine 113 from the controller 102 (e.g., in a single packet). The data transfer operation is performed without transferring the data over the interconnect 120. Performing the data transfer process without transferring the data 123 over the interconnect 120 may improve performance of the interconnect 120 compared to systems in which the data transfer operation includes the controller 102 reading the data from the first location 117 (e.g., using a first data transfer operation across the interconnect 120) and writing the data to the second location 119 (e.g., using a second data transfer operation across the interconnect 120).

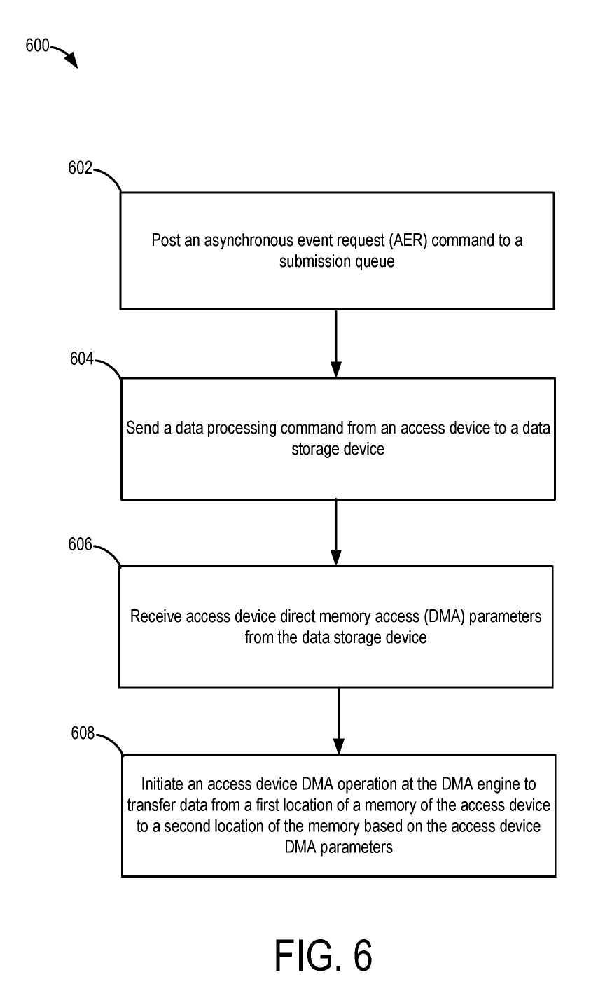

Referring to FIG. 6, a particular illustrative example of a method is depicted and generally designated 600. The method 600 may be performed at an access device, such as at the access device 130 of FIG. 1.

The method 600 includes posting, at 602, by the access device 130 to the submission queue 109 of FIG. 1. The method 600 includes sending, at 604, a data processing command or instruction to the data storage device 103 (e.g., to the controller 102). For example, the data processing instruction may correspond to a read instruction to read data from the memory 104 or a write instruction to write data (e.g., the data 123) to the memory 104. In some examples, the data indicated as the subject of the write instruction may be stored by the access device 130 at the first location 117 (e.g., at a host buffer of one or more host buffers) of the access device memory 106.

The method 600 may include, at 606, receiving access device DMA parameters, such as the access device DMA parameters 124 of FIG. 1, from the data storage device 103. The access device DMA parameters may cause the access device 130 to initiate an access device DMA operation to transfer data from the first location 117 of a memory of the access device (e.g., the access device memory 106) to a second location 119 of the memory (e.g., the access device memory 106) based on the access device DMA parameters 124 as described above with reference to FIG. 1.

The access device DMA parameters 124 may enable the access device 130 (e.g., the processor 111 or the access device DMA engine 113) to determine the first location 117 (e.g., an address of the first location 117) and the second location 119 (e.g., an address of the second location 119) as described above with reference to FIG. 1. In some examples, the access device DMA parameters 124 may be included in a completion queue entry posted to the completion queue 110 by the controller 102 as described above with reference to FIGS. 1 and 2. In some examples, the completion queue entry may correspond to the completion queue entry described above with reference to FIG. 2.

The method 600 may include, at 608, initiating an access device DMA operation at the DMA engine 113 of the access device 130 to transfer data from a first location of the memory of the access device to a second location of the memory of the access device based on the access device DMA parameters 124. For example, the access device DMA engine 113 may fetch the data 123 from the first location 117 determined based on the access device DMA parameters 124 and may write the data 123 to the second location 119 determined based on the access device DMA parameters 124. The access device 130 (e.g., the access device DMA engine 113) performs the fetch and write operations to fetch and write the data 123 from the first location 117 to the second location 119 using transactions between the access device memory 106 and the access device 130 (e.g., without transferring the data 123 across the interconnect 120).

Thus, the access device 130 may be configured to transfer the data 123 from the first location 117 to the second location 119 based on the access device DMA parameters 124 being sent to the access device 130 (e.g., being posted to the completion queue 110) from the controller 102, and the data transfer operation is performed without transferring the data 123 over the interconnect 120. Performing the data transfer process without transferring the data 123 over the interconnect 120 may improve performance of the interconnect 120 compared to systems in which the data transfer operation includes the controller 102 reading the data 123 from the first location 117 (e.g., using a first data transfer operation across the interconnect 120) and writing the data 123 to the second location 119 (e.g., using a second data transfer operation across the interconnect 120).

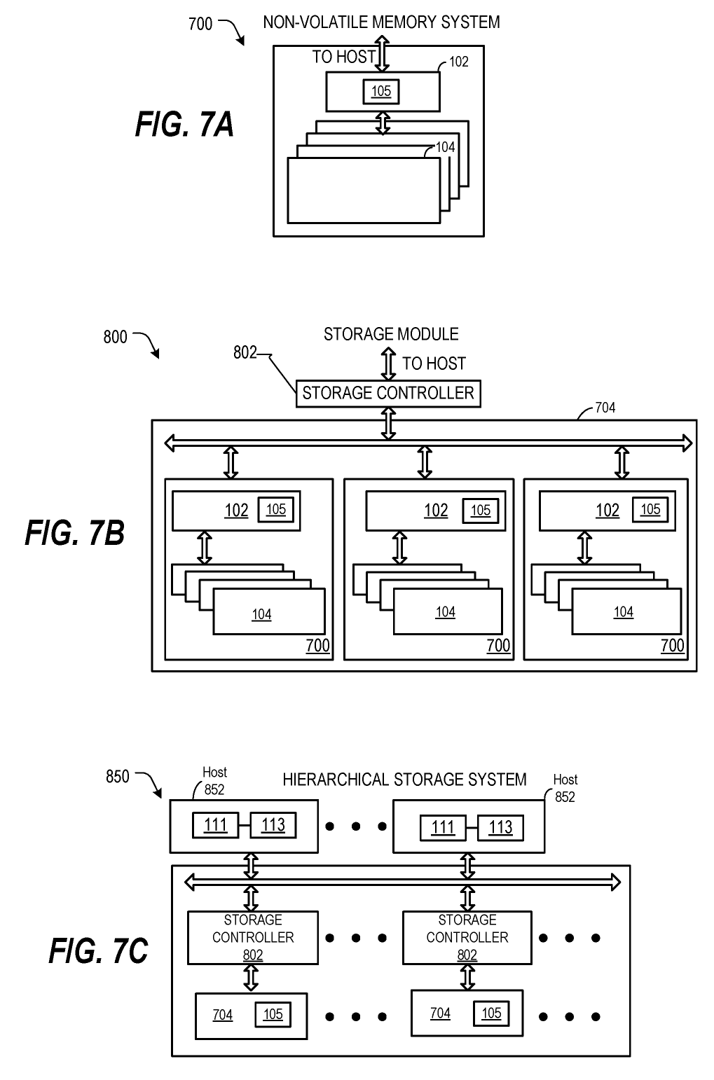

Memory systems suitable for use in implementing aspects of the disclosure are shown in FIGS. 7A-7C. FIG. 7A is a block diagram illustrating a non-volatile memory system according to an example of the subject matter described herein. Referring to FIG. 7A, a non-volatile memory system 700 includes the controller 102 and non-volatile memory that may be made up of one or more non-volatile memory die 104. As used herein, the term “memory die” refers to the collection of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104. The controller 102 may include the access device DMA initiator 105.

The controller 102 (which may be a flash memory controller) can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can be stored external to the controller, and other components can be used. Additionally, the phrase “operatively in communication with” could mean directly in communication with or indirectly (wired or wireless) in communication with through one or more components, which may or may not be shown or described herein.

As used herein, a flash memory controller is a device that manages data stored on flash memory and communicates with a host, such as a computer or electronic device. A flash memory controller can have various functionality in addition to the specific functionality described herein. For example, the flash memory controller can format the flash memory, map out bad flash memory cells, and allocate spare cells to be substituted for future failed cells. Some part of the spare cells can be used to hold firmware to operate the flash memory controller and implement other features. In operation, when a host is to read data from or write data to the flash memory, the host communicates with the flash memory controller. If the host provides a logical address to which data is to be read/written, the flash memory controller can convert the logical address received from the host to a physical address in the flash memory. (Alternatively, the host can provide the physical address.) The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between the controller 102 and the non-volatile memory die 104 may be any suitable flash interface, such as Toggle Mode 200, 400, or 800. In one embodiment, the non-volatile memory system 700 may be a USB flash drive or a card based system, such as a secure digital (SD) or a micro secure digital (micro-SD) card. In an alternate embodiment, memory system 700 may be part of an embedded memory system.

Although, in the example illustrated in FIG. 7A, the non-volatile memory system 700 (sometimes referred to herein as a storage module) includes a single channel between the controller 102 and the non-volatile memory die 104, the subject matter described herein is not limited to having a single memory channel. For example, in some NAND memory system architectures (such as the ones shown in FIGS. 7B and 7C), 2, 4, 8 or more NAND channels may exist between the controller and the NAND memory device, depending on controller capabilities. In any of the embodiments described herein, more than a single channel may exist between the controller 102 and the non-volatile memory die 104, even if a single channel is shown in the drawings.

FIG. 7B illustrates a storage module 800 that includes plural non-volatile memory systems 700. As such, storage module 800 may include a storage controller 802 that interfaces with a host and with storage system 704, which includes a plurality of non-volatile memory systems 700. The interface between the storage controller 802 and non-volatile memory systems 700 may be a bus interface, such as a serial advanced technology attachment (SATA) or peripheral component interface express (PCIe) interface. Storage module 800, in one embodiment, may be a solid state drive (SSD), such as found in portable computing devices, such as laptop computers, and tablet computers. Each controller 102 of FIG. 7B may include an access device DMA initiator, such as the access device DMA initiator 105.

FIG. 7C is a block diagram illustrating a hierarchical storage system. A hierarchical storage system 850 includes a plurality of storage controllers 802, each of which controls a respective storage system 704. Host systems 852 may access memories within the hierarchical storage system 850 via a bus interface. In one embodiment, the bus interface may be an NVMe or fiber channel over Ethernet (FCoE) interface. In one embodiment, the hierarchical storage system 850 illustrated in FIG. 7C may be a rack mountable mass storage system that is accessible by multiple host computers, such as would be found in a data center or other location where mass storage is needed. Each storage system 704 of FIG. 7C may be configured to include an access device DMA initiator 105.

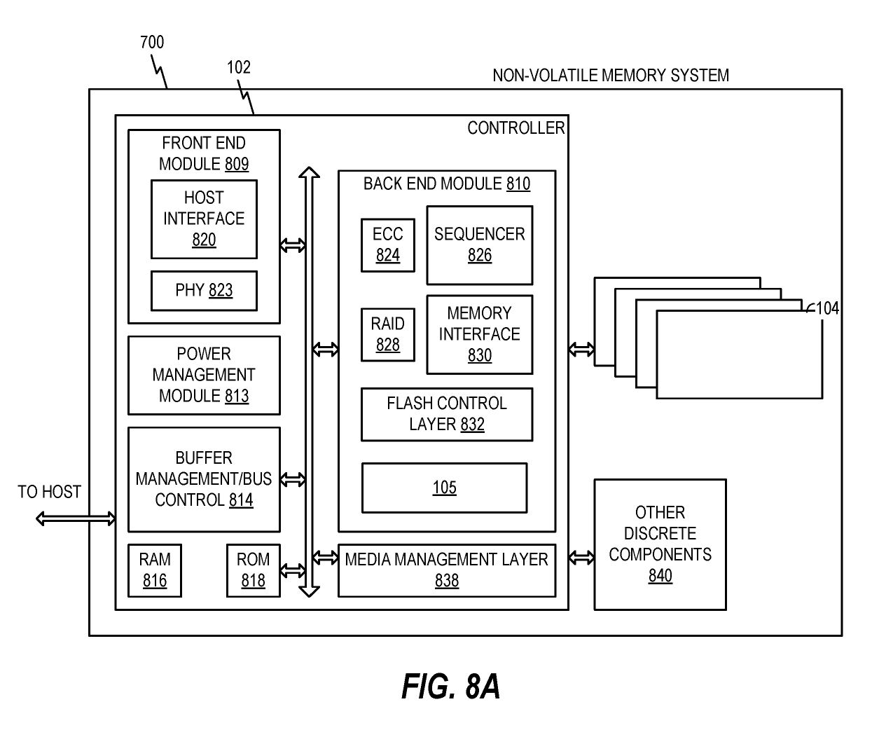

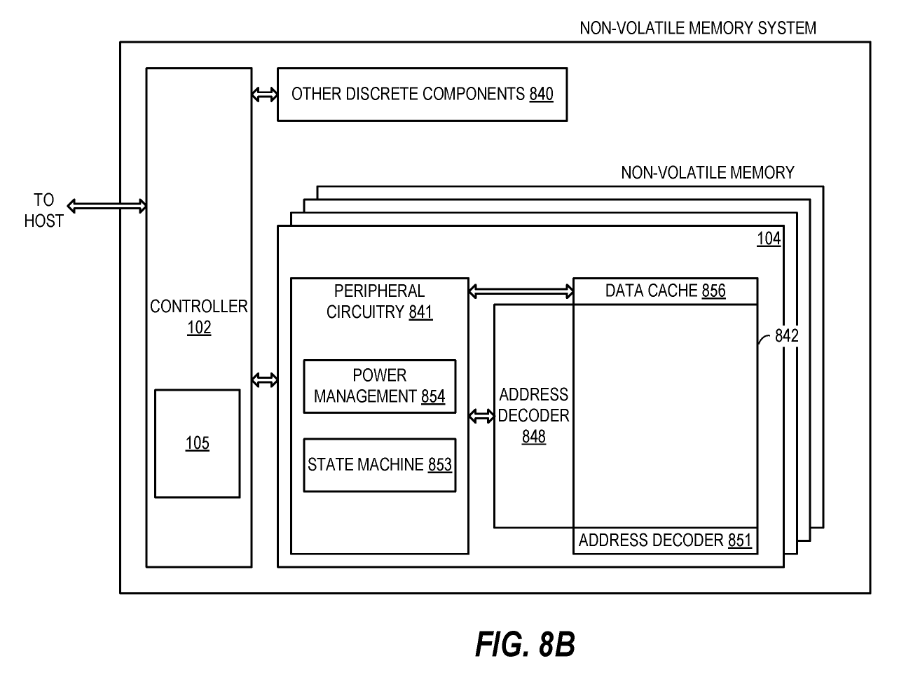

FIG. 8A is a block diagram illustrating exemplary components of controller 102 in more detail. Controller 102 includes a front end module 809 that interfaces with a host, a back end module 810 that interfaces with the one or more non-volatile memory die 104, and various other modules that perform other functions. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

Referring again to modules of the controller 102, a buffer manager/bus controller 814 manages buffers in random access memory (RAM) 816 and controls the internal bus arbitration of the controller 102. A read only memory (ROM) 818 stores system boot code. Although illustrated in FIG. 8A as located within the controller 102, in other embodiments one or both of the RAM 816 and the ROM 818 may be located externally to the controller 102. In yet other embodiments, portions of RAM and ROM may be located both within the controller 102 and outside the controller 102.

Front end module 809 includes a host interface 820 and a physical layer interface (PHY) 823 that provide the electrical interface with the host or next level storage controller. The choice of the type of host interface 820 can depend on the type of memory being used. Examples of host interfaces 820 include, but are not limited to, SATA, SATA Express, SAS, Fibre Channel, USB, PCIe, and NVMe. The host interface 820 typically facilitates transfer for data, control signals, and timing signals.

Back end module 810 includes an error correction code (ECC) engine 824 that encodes the data received from the host, and decodes and error corrects the data read from the non-volatile memory. A command sequencer 826 generates command sequences, such as program and erase command sequences, to be transmitted to non-volatile memory die 104. A RAID (Redundant Array of Independent Drives) module 828 manages generation of RAID parity and recovery of failed data. The RAID parity may be used as an additional level of integrity protection for the data being written into the non-volatile memory die 104. In some cases, the RAID module 828 may be a part of the ECC engine 824. A memory interface 830 provides the command sequences to non-volatile memory die 104 and receives status information from non-volatile memory die 104. For example, the memory interface 830 may be a double data rate (DDR) interface, such as a Toggle Mode 200, 400, or 800 interface. A flash control layer 832 controls the overall operation of back end module 810. The back end module 810 may also include the access device DMA initiator 105.

Additional components of system 700 illustrated in FIG. 8A include a power management module 813 and a media management layer 838, which performs wear leveling of memory cells of non-volatile memory die 104. System 700 also includes other discrete components 840, such as external electrical interfaces, external RAM, resistors, capacitors, or other components that may interface with controller 102. In alternative embodiments, one or more of the physical layer interface 823, RAID module 828, media management layer 838 and buffer management/bus controller 814 are optional components that are omitted from the controller 102.

FIG. 8B is a block diagram illustrating exemplary components of non-volatile memory die 104 in more detail. Non-volatile memory die 104 includes peripheral circuitry 841 and non-volatile memory array 842. The non-volatile memory cells may be any suitable non-volatile memory cells, including NAND flash memory cells and/or NOR flash memory cells in a two dimensional and/or three dimensional configuration. Peripheral circuitry 841 includes a state machine 853 that provides status information to controller 102, which may include the access device DMA initiator 105. The peripheral circuitry 841 may also include a power management or data latch control module 854. Non-volatile memory die 104 further includes discrete components 840, an address decoder 848, an address decoder 851, and a data cache 856 that caches data.

Although various components depicted herein are illustrated as block components and described in general terms, such components may include one or more microprocessors, state machines, or other circuits configured to enable the access device DMA initiator 105 of FIGS. 1, 7A, 7B, 7C, 8A, and 8B to initiate the access device DMA operation described above with reference to FIGS. 1 and 2. For example, the access device DMA initiator 105 may represent physical components, such as hardware controllers, state machines, logic circuits, or other structures, to cause the access device 130 to initiate the data transfer operation (e.g., transfer of the data 123 from the first location 117 to the second location 119). More particularly, the access device DMA initiator 105 may be configured to generate and populate the translation layer packet with the information described above with reference to FIG. 1. Alternatively or additionally, the access device DMA initiator 105 may be configured to generate, populate, and post the completion queue entry 200 of FIG. 2 to the completion queue 110 of the access device memory 106. The access device DMA initiator 105 may be implemented using a microprocessor or microcontroller programmed to generate and populate the translation layer packet or to generate, populate, and post the completion queue entry 200 of FIG. 2 to the completion queue 110.

In a particular embodiment, the data storage device 103 may be implemented in a portable device configured to be selectively coupled to one or more external devices. However, in other embodiments, the data storage device 103 may be attached or embedded within one or more host devices, such as within a housing of a host communication device. For example, the data storage device 103 may be within a packaged apparatus such as a wireless telephone, a personal digital assistant (PDA), a gaming device or console, a portable navigation device, or other device that uses internal non-volatile memory. In a particular embodiment, the data storage device 302 may include a non-volatile memory, such as a three-dimensional (3D) memory, a flash memory (e.g., NAND, NOR, Multi-Level Cell (MLC), a Divided bit-line NOR (DINOR) memory, an AND memory, a high capacitive coupling ratio (HiCR), asymmetrical contactless transistor (ACT), or other flash memories), an erasable programmable read-only memory (EPROM), an electrically-erasable programmable read-only memory (EEPROM), a read-only memory (ROM), a one-time programmable memory (OTP), or any other type of memory.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present invention is to be determined by the broadest permissible interpretation of the following claims and their equivalents, and shall not be restricted or limited by the foregoing detailed escription.

What is claimed is:

1. A data storage device comprising:
a memory; and
a controller coupled to the memory, the controller including an interface to enable the controller to be coupled to an access device that includes a direct memory access (DMA) engine, the controller configured to instruct the access device to perform an access device DMA operation to transfer data from a first location of a memory of the access device to a second location of the memory of the access device.

2. The data storage device of claim 1, wherein the first location of the memory of the access device corresponds to one or more host buffers, and wherein the second location of the memory of the access device corresponds to a host memory buffer (HMB).

3. The data storage device of claim 1, wherein the controller includes a register to store an address of a memory element associated with the DMA engine.

4. The data storage device of claim 3, wherein the controller is configured to instruct the access device to transfer the data by sending access device DMA parameters to the access device at the address.

5. The data storage device of claim 4, wherein the controller is configured to send the access device DMA parameters to the address by sending a translation layer packet that includes a source address field, a destination address field, and a transfer size field.

6. The data storage device of claim 5, wherein the source address field identifies the first location, the destination address field identifies the second location, and the transfer size field identifies a size of the data.

7. The data storage device of claim 1, wherein the controller is configured to receive an asynchronous event request (AER) command from the access device and to instruct the access device to perform the access device DMA operation by posting a completion queue entry to a completion queue of the access device.

8. The data storage device of claim 7, wherein the completion queue entry includes access device DMA parameters to activate the DMA engine to perform the access device DMA operation.

9. The data storage device of claim 8, wherein the completion queue entry includes a command specific field, a reserved field, a submission queue identifier field, a status field, or a combination thereof, and wherein the controller is configured to populate the command specific field, the reserved field, the submission queue identifier field, the status field, or a combination thereof with the access device DMA parameters.

10. An access device comprising:
a memory;
a direct memory access (DMA) engine; and
a processor coupled to the memory and to the DMA engine, the processor, the DMA engine, or both, configured to receive access device DMA parameters from a data storage device and to initiate an access device DMA operation at the DMA engine to transfer data from a first location of the memory to a second location of the memory based on the access device DMA parameters.

11. The access device of claim 10, wherein the first location of the memory corresponds to one or more host buffers and wherein the second location of the memory corresponds to a host memory buffer (HMB).

12. The access device of claim 10, wherein the processor is further configured to send an address of a memory element associated with the DMA engine to a vendor specific register of the data storage device.

13. The access device of claim 12, wherein the processor or the DMA engine is configured to initiate the access device DMA operation responsive to a translation layer packet including the access device DMA parameters being sent by the data storage device to the memory element associated with the DMA engine.

14. The access device of claim 10, wherein the memory includes a command completion queue and wherein the processor is configured to:
send an asynchronous event request (AER) command to the data storage device; and
initiate the access device DMA operation responsive to receiving a completion queue entry that includes the access device DMA parameters being posted to the command completion queue.

15. A method comprising:
receiving, at a data storage device, a data processing instruction from an access device; and
sending access device direct memory access (DMA) parameters from the data storage device to the access device to initiate an access device DMA operation to transfer data from a first location of a memory of the access device to a second location of the memory of the access device based on the access device DMA parameters.

16. The method of claim 15, further comprising determining an address of a memory element associated with an access device DMA engine based on an address stored in a vendor specific register of the data storage device.

17. The method of claim 16, wherein sending the access device DMA parameters includes sending a translation layer packet to the address of the memory element associated with the access device DMA engine determined based on the address stored in the vendor specific register.

18. The method of claim 15, further comprising receiving an asynchronous event request (AER) command at the data storage device from the access device, and wherein sending the access device DMA parameters includes posting a completion queue entry to a completion queue of the access device.

19. The method of claim 18, wherein the completion queue entry includes a command specific field, a reserved field, a submission queue identifier field, a status field, or a combination thereof, and wherein data storage device is configured to populate the command specific field, the reserved field, the submission queue identifier field, the status field, or a combination thereof with the access device DMA parameters.

20. The method of claim 15, wherein the first location corresponds to one or more host buffers of the memory and the second location corresponds to a host memory buffer (HMB).
